(19) United States
(12) Patent Application Publication
(10) Pub. No.: US 2002/0132091 A1
(43) Pub. Date: Sep. 19, 2002

(54) Micro-perforated temperature regulating fabrics, garments and articles having improved softness, flexibility, breathability and moisture vapor transport properties

(76) Inventor: James Brice Worley, Westminster, CO (US)

Correspondence Address: Brian P. Kinnear, HOLLAND & HART LLP, P.O. Box 8749, Denver, CO, 80201, US

(21) Appl. No.: 09/851,306

(22) Filed: May 8, 2001

Related U.S. Application Data
(60) Provisional application No. 60/264,110, filed on Jan. 25, 2001.
(60) Provisional application No. 60/264,187, filed on Jan. 25, 2001.

(51) Int. Cl. B32B 3/10; B05D 3/12

(52) U.S. Cl. 428/138; 427/289

(57) ABSTRACT

A temperature-regulating fabric, such as a relatively flexible cloth or textile sheet, a relatively flexible foam sheet, a relatively flexible film, a relatively flexible plastic sheet, a relatively flexible paper, or a relatively flexible leather includes a continuous coating on at least one side thereof that contains one or more phase change materials or micro-encapsulated phase change materials. Micro-perforations are formed in this continuous coating to improve the softness, flexibility, breathability and moisture transport properties of the fabric and of garments or articles that are made using the fabric.

### CROSS-REFERENCE TO RELATED APPLICATIONS

This application claims the benefit of provisional patent application Serial No. 60/264,110 filed Jan. 25, 2001.

This application is related to co-pending provisional patent application serial No. 60/264,187 filed Jan. 25, 2001 and entitled TEMPERATURE REGULATING FABRICS AND GARMENTS HAVING A DISCONTINUOUS PCM/mPCM COATING THAT PROVIDES IMPROVED FABRIC/GARMENT FLEXIBILITY, BREATHABILITY, SOFTNESS, AND MOISTURE VAPOR TRANSPORT PORPERTIES incorporated herein by reference.

### BACKGROUND OF THE INVENTION

1. Field of the Invention

This invention relates to the field of temperature-regulating fabrics, and to garments or articles that are formed from such fabrics wherein the presence of Phase Change Material(s) (PCMs) provides a temperature-regulating property to the fabrics/garments/articles.

2. Description of the Related Art

It is known that temperature-regulating fabrics, garments, or articles are manufactured by applying a continuous coating that contains one or more PCMs to at least one side of a fabric(s), and that garments and/or articles are then formed from the continuously-coated fabric(s).

The fabric PCM coating(s) can be formed using various coating formulations, each coating formulation containing one or more unencapsulated PCMs (also known as raw PCMs), or each coating formulation containing one or more PCM(s) that are housed or contained within a plurality of microcapsules (also known as microencapsulated PCMs, or mPCMs).

Once such a continuous PCM coating(s) is applied to a fabric, the fabric (and garments and articles that are made from the fabric) may become stiff and “boardy” as a result of the binder that is within the continuous PCM coating(s), as a result of the PCM/mPCM that is within the continuous PCM coating(s), and as a result of the continuous and moisture-impermeable nature of the continuously-coated fabric, thereby reduced the fabric softness, flexibility, breathability and moisture transport properties.

These reduced properties of such a continuously PCM-coated fabric can detract from the comfort of an individual wearing a garment or using an article that is made from the fabric.

Textile processes, such as lofting, are also known wherein a relatively soft lofted or protruding insulation layer is produced on one surface of a fabric by “needling” the fabric; i.e., by needle punching the fabric, with the needles usually entering and then exiting this one surface o side of the fabric. This needling process is accomplished by pushing barbed needles into this one side of the fabric, and then reversing movement of the barbed needles in order to pull fibers back up through the fabric, thus locking the fibers into one side of the fabric as a lofted layer.

### SUMMARY OF THE INVENTION

In order to increase the softness, flexibility, breathability, and moisture transport properties of PCM/mPCM continuous-coated flexible fabrics/garments/articles, the present invention provides for the needling or needle punching of the continuously PCM coated flexible fabrics, whereby needles that are barbed or un-barbed are pushed through the fabric thereby forming micro-perforations or micro-size holes in the fabric.

The invention also finds utility when used to micro-perforate substrates that are relatively inflexible, in which case, micro-perforation in accordance with the invention operates to increase the softness, breathability and moisture transport properties of PCM/mPCM continuous-coated inflexible articles.

While not critical to the invention, a well-known needle loom may be used to micro-perforate a PCM/mPCM continuous-coated fabric in accordance with the invention. In addition, the depth of needle penetration can be varied if desired. Other equivalent needling means are considered to be within the spirit and scope of this invention, such equivalent means including both presently-existing means, and means that are developed hereafter.

While a conventional definition of the term “fabric” as it relates to the textile field is a woven or non-woven material that resembles cloth, as used herein, the term “fabric” is intended to mean a relatively flexible woven or non-woven cloth or textile material, a relatively flexible foam, a relatively flexible film, a relatively flexible plastic, a relatively flexible paper, and a relatively flexible leather, all of which are of a type that can be continuously coated or contain, on at least one side thereof, a thin temperature-regulating layer that contains one or more PCMs/mPCMs.

In one embodiment of the invention, the continuously PCM coated fabric does not include a lofted insulation backing layer, and non-barbed needles are used to penetrate only one surface, or entirely through the fabric. In this embodiment of the invention, a lofted layer is not formed on the needle entrance/exit side of the fabric.

In another embodiment of the invention, the continuously PCM coated fabric is a fabric, such as a quilted fabric that includes a lofted insulation backing; for example, a quilted fabric. In this embodiment, barbed needles can be used to form a lofted layer on the needle entrance/exit side of the fabric.

These and other advantages and features of the invention will be apparent to those of skill in the art upon reference to the following detailed description of the invention, which description makes reference to the drawing.

### BRIEF DESCRIPTION OF THE DRAWING

FIG. 1 is a planar view of a piece of temperature-regulating textile cloth having micro-perforations in accordance with the invention.

FIG. 2 is a greatly enlarged side section view of a small portion of the cloth shown in FIG. 1, this figure showing a number of small holes that comprise micro-perforations in accordance with the invention, this figure showing that the needle penetration depth has been selected so as to not penetrate entirely through the cloth, and this figure showing a continuous PCM/mPCM coating that has been applied to the needle entry/exit side of the cloth.

FIG. 3 is generally similar to FIG. 2 wherein a continuous PCM/mPCM coating has been applied to both sides of the fabric, and the needle penetration depth has been selected so as to penetrate entirely through the fabric.

FIG. 4 is a planar view of a piece of quilted temperature-regulating fabric having a number of individual holes that comprise micro-perforation in accordance with the invention.

FIG. 5 is a greatly enlarged side view of a small portion of the quilted fabric shown in FIG. 4, this figure showing a relatively thick non-woven insulation layer that lies directly below a relatively thin and continuously PCM/mPCM coated fabric layer of the type shown in FIG. 2, and this figure showing that the penetration depth of un-barbed needles has been selected so as to not penetrate entirely through the non-woven insulation layer

FIG. 6 is a greatly enlarged side view similar to FIG. 5 wherein barbed needles have been used to snag fibers from the non-woven insulation layer so as to produce a lofted layer of fibers above the continuous PCM/mPCM coating and on the needle entry/exit side of the quilted fabric.

FIG. 7 is a greatly enlarged side view similar to FIG. 7 wherein the bottom surface of the non-woven insulation layer is also covered by a relatively thin continuously PCM/mPCM coated fabric layer of the type shown in FIG. 2, and wherein barbed needles penetrate entirely through the quilted fabric.

FIG. 8 shows an embodiment of the invention wherein one surface of a temperature-regulating foam is micro-perforated in accordance with the invention.

FIG. 9 shows an embodiment of the invention wherein one surface of a temperature-regulating leather is micro-perforated in accordance with the invention.

FIG. 10 shows an embodiment of the invention wherein a semi-permeable membrane is coated with a continuous layer that contains at least one PCM/mPCM, the membrane then being micro-perforated in accordance with the invention.

### DESCRIPTION OF THE PREFERRED EMBODIMENTS

The present invention provides that fabrics (as above defined) that are continuously coated with a coating layer that contains PCM/mPCM are micro-perforated in order to improve the fabric's physical properties, non-limiting examples of which are softness, flexibility, the ability to breath, and the ability to transport moisture vapor.

While the type of PCM/mPCM that is used in the fabric PCM/mPCM coating formulation(s) in accordance with the invention is not a limitation on the spirit and scope of the invention when mPCM is used in the coating formulation, the mPCM can contain any grade or type of PCM, but preferably the PCM comprises straight chain alkanes of the C10 to C30 variety.

The type of binder that is used in a fabric PCM/mPCM coating formulation(s) is not a limitation on this invention, and the coating formulations may include any known binder with acrylic binders, polyurethane binders, natural and synthetic rubber binders, silicon rubber binders and/or any other polymer binder type systems being preferred.

As a result of the invention, a large plurality of micro-perforations (i e., small diameter through holes) are formed in the fabric continuous PCM/mPCM coating, to thereby increase the softness, flexibility, breathability and moisture vapor transport properties of coated fabrics and of garments/articles that are made from the coated fabrics.

The invention's micro-perforation process also flexes or “mechanically works” the fabric's PCM/mPCM coating, thereby decreasing the fabric stiffness all without decreasing the physical strength of the fabric.

Measuring the water of Moisture Vapor Transport Rate (MVTR) of a fabric/garment/article that is made in accordance with the invention provides a means of determining the amount of moisture vapor that passes through the fabric/garment/article during a given time period.

In this case, the present invention was MVTR tested using a saturated salt solution method. Using this method, water or moisture vapor transmission rates are measured by placing a saturated salt solution/slurry into a 140 ml. polypropylene cup having an inside diameter of 6 l cm at its mouth An ePTFE membrane having a minimum water vapor transmission rate of approximately 72,000 grams/m²/24 hrs. (as tested by the method described in U.S. Pat. No. 4,862,730 to Crosby incorporated herein by reference) was heat sealed to the lip of the cup to create a taut, leakproof, microporous barrier containing the solution.

A similar ePTFE membrane was mounted, stretched taut, and held in an embroidery hoop which was floated on the water bath. The water bath assembly was controlled at 25° C.±0.2° C., utilizing a temperature-controlled room and a water circulating bath. The sample to be tested was allowed to condition at a temperature of 22° C. and a relative humidity of 50% prior to performing the test procedure.

Three samples were placed so that each sample to be tested was in contact with the ePTFE membrane mounted in the hoop and floating on the water bath.

The cup assembly was weighed to the nearest 1/1000 gram and was inverted onto the center of the test samples.

Water transport was provided by a driving force between the water in the water bath and the saturated salt solution providing water flux by diffusion in that direction. The sample was tested for 10 minutes and the cup assembly was then removed and weighed again to within 0.001 grams.

The water vapor transmission rate of the sample was calculated from the weight gain of the cup assembly, and was expressed in grams of water per square meter of sample surface area per 24 hours.

Using this procedure with a saturated sodium chloride (NaCl) salt solution, a measurement of the water vapor transport rate of a PCM/mPCM continuous-coated fabric that did not include micro-perforations in accordance with the invention was less than about 50 grams/m²/24 hours, whereas a micro-perforated PCM/mPCM continuous coated and micro-perforated fabric in accordance with the invention at a hole density of about 1400 holes/inch² increased the transmission rate of the fabric to about 2000 grams/m²/hr.

A similar test was performed using a saturated potassium acetate (KOAc) salt solution. In this case, the transmission rate was tested for fabrics having hole densities of 0 holes per square inch, 1400 holes per square inch, and 2100 holes per square inch. These samples resulted in vapor transmission rates of:

| Sample Hole Density | Transmission Rate | |
|---|---|---|
| (holes/inch²) | (grams/m²/24 hrs) | Description |
| 0 | 1,064 | No micro-perforations |
| | | (control) |
| 1400 | 6,825 | Standard micro-perforations |
| 2100 | 10,936 | 50% additional micro- |
| | | perforations |

As can be seen, increasing the density of the perforations increase the transmission rate of the garment.

While the unit area density of micro-perforations are not a critical limitation on the spirit and scope of the invention, this unit area micro-perforation density should be low enough so as to not appreciably disturb the tensile strength and the temperature-regulating property of the temperature-regulating fabric, and the unit area density of fabric micro-perforations should be high enough to appreciably improve the fabric softness, flexibility, breathability and moisture transfer. Generally stated, as the unit area density of the fabric micro-perforations increases, all four of the above properties of the micro-perforated fabric increase with only a slight, and usually immeasurable, concomitant loss in the tensile strength and temperature-regulating properties of the micro-perforated fabric.

Hole densities from about 10 to about 5000 micro-perforations per square inch are suggested, depending upon the end use of the micro-perforated fabric, with hole densities from about 1400 to about 2800 per square inch being preferred for most applications of the micro-perforated fabric of the invention.

The needles that are used to form micro-perforations in accordance with the invention are preferably metal needles of well-known construction. Such needles may be about 1/10^{th} mm in diameter, and they may have a cross-sectional shape that is selected from the group square, rectangular, round, oval, and triangular.

The physical pattern of the micro-perforation of a temperature-regulating fabric in accordance with the invention may comprise a plurality of uniformly spaced micro-perforations, a plurality of randomly spaced micro-perforations, a plurality of micro-perforations some of which are uniformly spaced and others of which are randomly spaced, or a plurality of micro-perforations that are spaced in accordance with a geometric pattern that is selected as a function of an intended use of the fabric.

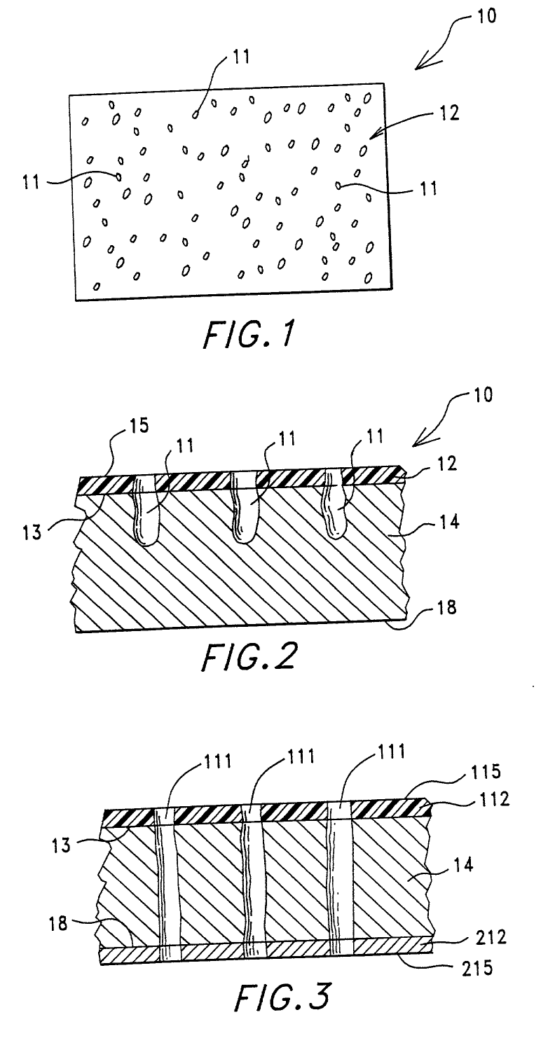

FIG. 1 is a planar (top or bottom) view of a relatively thin piece of temperature-regulating cloth-like fabric 10 having a plurality of micro-perforations or through holes 11 in accordance with the invention. Micro-perforations 11 are formed within fabric 10 by means of a fabric needling process/machine, the details of which are well known and will not be described herein.

The invention will be described while making reference to fabrics that have at least a portion of one side, or at least a portion of both sides thereof continuously coated with a PCM/mPCM containing material; for example, coated with a liquid that contains at least a binder and PCM/mPCM. However, the invention also has utility when garments and other articles are made from the micro-perforated temperature-regulating fabric. In addition, and in accordance with the invention, it is possible that only a selected portion of the fabric continuous PCM/mPCM coating will be micro-perforated; for example, as a function of the manner in which the fabric/garment/article is used.

FIG. 2 is a greatly enlarged side/section view of FIG. 1 PCM/mPCM coated fabric 10. FIG. 2 better shows a number of the individual micro-perforations or holes 11 that do not completely penetrate the thickness of fabric 10 and that comprise the micro-perforating of fabric 10 in accordance with the invention. Of course, it is possible for micro-perforations or holes 11 to completely penetrate the fabric 10. Also, as seen in this figure, a thin and continuous PCM/mPCM coating 12 is carried by the top surface 13 of a woven or non-woven fiber layer 14.

The fiber composition of fiber layer 14 is not critical to the invention In practice, fiber layer 14 is coated with a continuous PCM/mPCM coating 12 using any of a variety of known means which coating means are well known and will not be described herein.

In the embodiment of the invention shown in FIGS. 1 and 2, the needles used in the needling process were un-barbed needles that entered and then exited the top side 15 of fabric 10. In this embodiment, no upward-extending lofting portions are associated with each micro-perforation 11.

FIG. 3 shows and embodiment of the invention wherein fiber layer 14 contains a first continuous PCM/mPCM coating 112 on its top surface 13 and a second continuous coating 212 on its bottom surface 18. Coating 212 may or may not contain PCM/mPCM, as is desired. While the needle perforation can be as shown in FIG. 2, FIG. 3 shows that the individual micro-perforations or holes 111 completely penetrate the thickness of the FIG. 3 fabric, in which case, either side of the fabric can be the needle entry/exit side. Again, un-barbed needles are used to form the FIG. 3 embodiment.

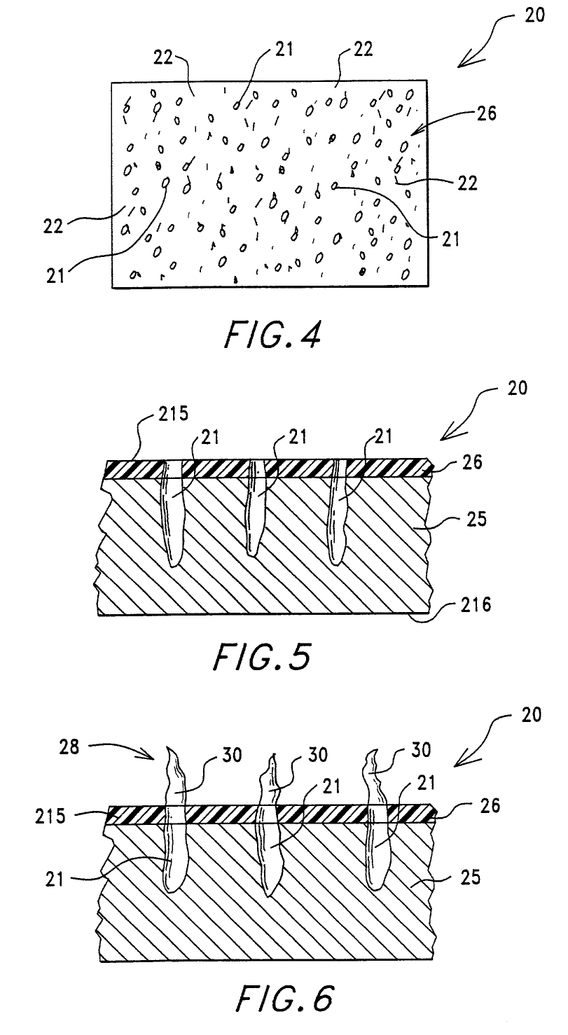

FIG. 4 is a planar view of a relatively thicker piece of quilted temperature-regulating fabric or cloth 20, this quilted fabric having at least one external surface that comprises a thin fabric layer of the type shown in FIG. 1. Quilted fabric 20 includes a number of individual holes 21 that comprise the micro-perforation of quilted fabric 20 in accordance with the invention. As is conventional, quilted fabric 20 includes a plurality of generally orthogonally related or perhaps pattern-configured stitch lines 22.

FIG. 5 is a greatly enlarged side view of quilted fabric 20, this figure showing a relatively thick layer of non-woven insulating/insulation layer 25 that lies directly below a relatively thin top layer of a PCM/mPCM coated woven or non-woven fabric 26. In this embodiment, it is seen un-barbed needles are used to partially penetrate quilted fabric 20 from its topside 215 to thus form a plurality of micro-perforations or holes 21. Of course, the needles could be used to completely penetrate quilted fabric 20.

A use specific lining layer (not shown) may be provided on at least one surface 215, 216 of quilted fabric 20; for example, when quilted fabric 20 comprises a portion of the lining of a shoe.

FIG. 6 is an embodiment similar to FIG. 5 wherein the use of barbed needles results in the production of a lofted layer 28 that extends upward and above top surface 28, lofted layer 28 being formed of fibers 30 that have been snagged from insulating layer 25 by the barbed needles so as to lift fibers 30 up and out of holes 21. As a result, not only is the quilted fabric micro-perforated in accordance with the invention, but, in addition, a relatively soft lofted layer 28 is produced on the needle entry/exit side 215 of the quilted fabric.

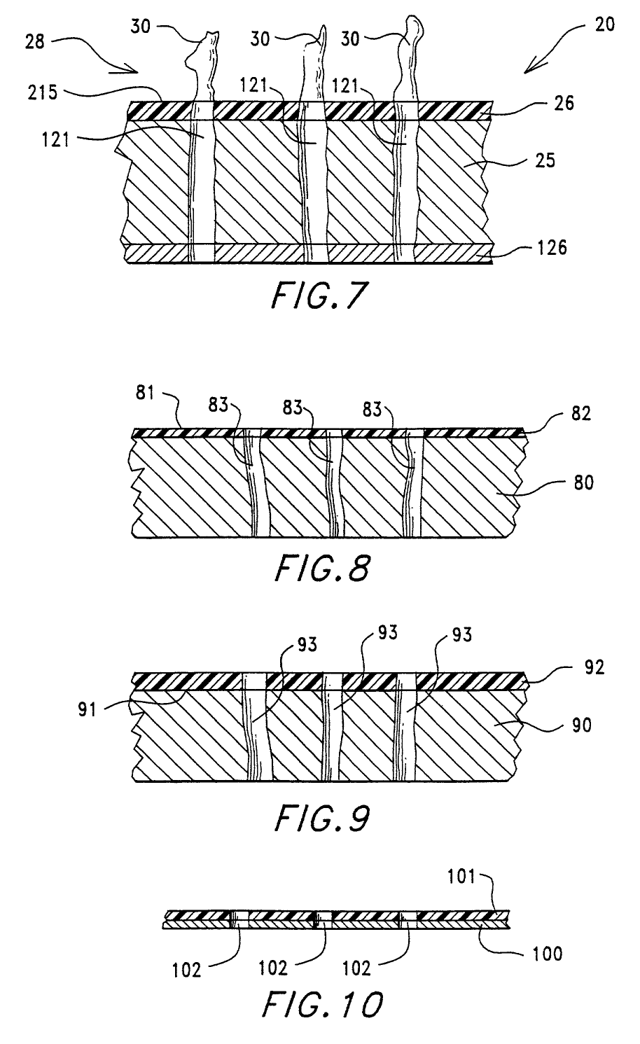

In the FIG. 7 embodiment of the invention, barbed needles are again used to form a lofted layer 128. However, in this embodiment, the bottom layer 126 of the quilted fabric comprises a second thin fabric layer 126 of the type shown in FIG. 1. In this embodiment, the needles enter and exit by way of top surface 215 after having penetrated completely through the quilted fabric so as to form micro-perforations 121 that are through holes that completely penetrate the quilted fabric.

FIG. 8 is a greatly enlarged section view of an embodiment of the invention wherein a foam sheet 80 has its top surface 81 continuously coated with a PCM/mPCM containing layer 82, and wherein a plurality of micro-perforations 83 completely or partially penetrate foam sheet 80.

FIG. 9 is a greatly enlarged section view of an embodiment of the invention wherein a leather member 90 has its top surface 91 continuously coated with a PCM/mPCM containing layer 92, and wherein a plurality of micro-perforations 93 completely or partially penetrate leather member 92.

With reference to FIG. 10, an embodiment of the invention is shown wherein a semi-permeable membrane 100 is continuously coated with a coating 101 that contains PCM/mPCM. An example of such a semi-permeable membrane 100 is the brand Gore-Tex. The composite assembly 100/101 is then micro-perforated at 102 in accordance with this invention. In this utility of the invention, micro-perforations 102 do not compromise or hinder the moisture vapor transfer rate or the permeability of the composite assembly 100/101 while at the same time providing improved softness, flexibility, breathability and temperature regulation to the composite assembly.

In a manner as above described, micro-perforations in accordance with the invention may be formed in the continuous temperature-regulating coating of any fabric, such as a relatively flexible cloth or textile material, a relatively flexible foam, a relatively flexible film, a relatively flexible plastic, a relatively flexible paper, or a relatively flexible leather, all of which have a continuous coating on at least one side thereof that contains one or more PCMs/mPCMs.

The invention has been described while making detailed reference to embodiments of the invention. However, since it is known that others will, upon learning of this invention, readily visualize yet other embodiments that are within the spirit and scope of this invention, this detailed description is not to be taken as a limitation on the spirit and scope of this invention. In addition, while specific means for implementing the invention have been disclosed, the spirit and scope of the invention is intended to include exiting equivalent means and after-developed equivalent means.

What is claimed is:

1. A temperature-regulating substrate comprising:
a substrate having a continuous coating that contains phase change material on at least a portion of at least one side of said substrate; and
a plurality of micro-perforations penetrating at least a portion of said continuous coating.

2. The temperature-regulating substrate of claim 1 wherein the density of said micro-perforations is from about 10 to about 5000 micro-perforations per square inch.

3. The temperature-regulating substrate of claim 2 wherein said micro-perforations have a cross-sectional size of about 0.1 mm.

4. The temperature-regulating substrate of claim 3 wherein a cross-sectional shape of said micro-perforations is selected from a group consisting of square, rectangular, round, oval and triangular.

5. The temperature-regulating substrate of claim 1 wherein a density of said micro-perforations is from about 1400 to about 2800 micro-perforations per square inch.

6. The temperature-regulating substrate of claim 5 wherein said micro-perforations are each about 0.1 mm in diameter.

7. The temperature-regulating substrate of claim 1 wherein said substrate is a flexible fabric-like member selected from the group cloth, foam, film, plastic, paper and leather.

8. The temperature-regulating substrate of claim 7 wherein a density of said micro-perforations is from about 1400 to about 2800 micro-perforations per square inch

9. The temperature-regulating substrate of claim 8 wherein said micro-perforations are about 0.1 mm in size.

10. A temperature-regulating fabric-like member selected from the group cloth, foam, film, plastic, paper and leather, comprising:
a fabric-like member having a continuous coating that contains phase change material on at least a portion of at least one side of said fabric-like member, and
a plurality of micro-holes having a cross sectional size of about 0.1 mm and having a density of from about 10 to about 5000 micro-holes per square inch penetrating at least a portion of said continuous coating.

11. The temperature-regulating fabric-like member of claim 10 wherein a cross-sectional shape of said micro-holes is selected from a group consisting of square, rectangular, round, oval and triangular.

12. The temperature-regulating fabric-like member of claim 11 wherein a density of said micro-holes is from about 1400 to about 2800 micro-holes per square inch.

13. A method of making a temperature-regulating article having improved softness, improved breathability and improved moisture transport properties comprising the steps of:
providing a two-sided article;
continuously coating at least one portion of at least one side of said article with a coating that contains a phase change material; and
micro-perforating at least a portion of said continuous coating.

14. The method of claim 13 wherein said two-sided article is a flexible article selected from the group cloth, foam, film, plastic, paper, and leather.

15. The method of claim 13 wherein said step of micro-perforating includes the step of forming micro-holes at a density of about 10 to about 5000 micro-holes per square inch within at least said portion of said coating.

16. The method of claim 15 wherein said micro-holes are about 0.1 mm in diameter.

17. The method of claim 16 wherein said two-sided article is a flexible article selected from the group cloth, foam, film, plastic, paper and leather

18. The method of claim 13 wherein a density of said micro-perforations is from about 1400 to about 2800 micro-holes per square inch, and wherein said micro-holes are each about 0.1 mm in diameter.

19. The method of claim 18 wherein said two-sided article is a flexible article selected from the group cloth, foam, film, plastic, paper and leather.

20. A method of making an insulating and temperature-regulating article having improved softness, flexibility, breathability and moisture transport properties comprising the steps of:
providing a relatively thick layer of insulating fibers having two exposed surfaces;
providing a relatively thin fabric member on at least a portion of at least one surface of said relatively thick layer of insulating fibers;
said fabric member having two surfaces;
said fabric member having a continuous coating that contains phase change material on at least a portion of one surface thereof; and
forming a plurality of micro-perforations that penetrate at least a portion of said continuous coating.

21. The method of claim 20 wherein a density of said micro-perforations is from about 10 to about 5000 micro-perforations per square inch of said continuous coating.

22. The method of claim 21 wherein said micro-perforations are about 0.1 mm in diameter.

23. The method of claim 20 wherein a density of said micro-perforations is from about 1400 to about 2800 holes per square inch of said continuous coating, and wherein said micro-perforations are about 0.1 mm in diameter.

24. The method of claim 20 including the step of:
stitching said layer of insulating fibers and said fabric member together to form a quilted fabric.

25. The method of claim 24 wherein said step of forming a plurality of micro-perforations includes the steps of:
providing barbed needles to form said micro-perforations, and
using said barbed needles to snag fibers from said relatively thick layer of insulating fibers, and thereby form a lofted layer of fibers on a surface of said quilted fabric.

26. A temperature-regulating article comprising:
a semi-permeable membrane having a first side and an opposite side;
a continuous coating containing at least one phase change material on at least one side of said semi-permeable membrane; and
micro-perforations penetrating at least portion of said continuous coating and said semi-permeable membrane.

27. The temperature-regulating article of claim 26 wherein said micro-perforations are formed at a density of about 10 to about 5000 micro-perforations per square inch.

28. The temperature-regulating article of claim 27 wherein said micro-perforations have a diameter of about 0.1 mm.
